(19) United States
(12) Patent Application Publication
(10) Pub. No.: US 2024/0121313 A1
(43) Pub. Date: Apr. 11, 2024

(54) PRIORITIZED WIRELESS PRESENCE ACCESS CONTROL SYSTEM

(71) Applicant: JABAA, LLC, Garland, ME (US)

(72) Inventor: Michael L. Smith, Sebastian, FL (US)

(73) Assignee: JABAA, LLC, Garland, ME (US)

(21) Appl. No.: 17/784,548

(22) PCT Filed: Dec. 11, 2020
(86) PCT No.: PCT/US2020/064564

§ 371 Date: Oct. 19, 2022

Related U.S. Application Data
(60) Provisional application No. 62/947,119, filed on Dec. 12, 2019.

(51) Int. Cl. H04L 67/12; H04L 67/1004; H04L 67/51

(52) U.S. Cl. CPC H04L 67/12; H04L 67/1004; H04L 67/51

(57) ABSTRACT

A Bluetooth (“BT”)-enabled access control system (“ACS”) for enabling selective entrance and use of resources and spaces based on a connectionless presence device according to an access security policy is provided. The system, in some embodiments comprises an Access Point Gate-way (“APG”), the APG being in electronic communication with at least one Access Control Module (“ACM”) proximate to the APG, the at least one ACM being in communication with the connectionless presence device, and the APG including at least one Access Point Module (“APM”) and at least one Access Control Module (“ACM”), the APM being enabled to discover, monitor, and balance the communications load of connectionless presence devices using the at least one ACM.

### 1 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2019, Biometric Associates, LP.

### 2 BACKGROUND OF THE TECHNOLOGY

### 2.1 Field of the Technology

The exemplary, illustrative, technology herein relates to an access control system that interacts with wireless presence indicating devices that broadcast connectionless presence information. The access control system includes one or more access modules, each of which tracks one or more of the wireless presence indicating devices by monitoring the connectionless presence information being broadcast by the devices. The access control system includes a load balancer that determines which access control modules connect with which wireless presence indicating devices such that resource loads on the access control modules are reduced or minimized.

Each access control module selectively establishes one or more communication sessions with one or more wireless presence indicating devices in order to exchange data about the device user, and then use this data for making access control decisions. The access control system interacts with at least one access controlling mechanism such as a door lock or computerized terminal login device and, based on results of an access control decision, causes the access controlling mechanism to allow or prevent a user of a portable presence device to access a resource protected by the access controlling mechanism.

The technology herein has applications in the areas of security, access control.

### 2.2 the Related Art

Current Bluetooth-enabled access control points control access to a physical resource, but are limited in the number of Bluetooth devices that it communicates based upon aspects of the BT protocols. The challenge is that, because of the overhead inherent in the BT pairing required in order to obtain identity and authentication information from the Bluetooth device corresponding to its current user, the BT-enabled access control point can only establish a connection with a limited number of nearby Bluetooth devices. For this reason, current BT-enabled access control points are limited in the number of simultaneous communication sessions they can establish with Bluetooth devices, which limits their use to low traffic volume applications.

Current BT-enabled access control points are unable to monitor, distribute, and prioritize the Bluetooth devices that they connect with, resulting in numerous issues as the number of devices communicating with the access control point increases. Each communication session between a Bluetooth-enabled access control point and a Bluetooth device consumes resources such as memory and processor cycles. Thus, as multiple Bluetooth devices each establish communication sessions with a Bluetooth-enabled access control point, performance is lost and access decision latency is increased with each subsequent connection. Additionally, if the limited access control point capacity is occupied by communicating with lower priority devices, a high priority device is unable to connect to the access control point to be granted access. Existing Bluetooth-based access control architectures are thus not scalable for large numbers of nearby devices. This poses challenges in crowded areas where a large number of devices are simultaneously present, and when large numbers of Bluetooth devices regularly move in and out of range of an access control point. Additionally, multiple Bluetooth devices within close proximity to an existing technology wireless-enabled access point interfere with each other's operation, effectively denying access to authorized device holders.

In each of the above cases, the BT-enabled access control points are making access control decisions based upon the presence of a specific Bluetooth-enabled device, but remain unaware of the user of the device without a resource-intensive second stage user identification and authentication process, which necessitates the use of a bi-directional communication session between the access control point and the device. As described above, these bi-directional communication sessions limit the number of devices that can connect to an access control point.

Moreover, current Bluetooth (BT)-access points with multiple antennas and access control systems that include multiple BT base stations to provide connection resources usable by multiple Bluetooth devices. The current state of the art does not adequately solve connectivity limitations associated with access point overhead required for the BT pairing in order to obtain identity and authentication information from the BT devices.

The system and methods described herein alleviate these and other challenges.

### 3 Summary of the Technology

In one aspect, the present invention provides a Bluetooth (“BT”)-enabled access control system (“ACS”) for enabling selective entrance and use of resources and spaces based on a connectionless presence device according to an access security policy. In some embodiments, the system comprises: an Access Point Gate-way (“APG”), the APG being in electronic communication with at least one Access Control Module (“ACM”) proximate to the APG, the at least one ACM being in communication with the connectionless presence device, and the APG including at least one Access Point Module (“APM”) and at least one Access Control Module (“ACM”), the APM being enabled to discover, monitor, and balance the communications load of connectionless presence devices using the at least one ACM.

In some more specific embodiments, the APM further includes an Access Card State (“ACS”) data store and a Load Balancer, the Load Balancer being configured to communicate with the at least one ACM and the ACS data store. In more specific embodiments, the APM further includes a Discovery Module and a BT Connection Monitoring Module. Still more specific embodiments further include a Biometric Verification Module (“BVM”) that verifies at least one biometric parameter related to a connectionless presence device. In yet more specific embodiments, the BVM communicates electronically with a Biometric Input Device (“BID”). In some embodiments, the BID includes at least one input device selected from the group consisting of a camera, a fingerprint scanner, an iris scanner, or a palm print scanner. In other embodiments, the APM further includes a Personalized Identity Data Store.

Returning to the basic ACS embodiments summarized above, in some more specific embodiments, the ACS comprises a plurality of APGs. In more specific embodiments, one of the plurality of APGs is a master APG, the master APG interacting with, and making access control decisions, for all of the connectionless presence devices. In still more specific embodiments, the remainder of APGs other than the master APG interact with and make access control decisions for a subset of the connectionless presence devices, the subset being enrolled and authorized by the master APG, the remainder of APGs being provisioned with a list that includes only the subset of connectionless presence devices and each of the remainder of the APGs interacting only with the connectionless presence devices on the provisioned list.

In a second aspect, the present invention provides a method for controlling access to resources and spaces using one or more connectionless presence devices on a Bluetooth (“BT”)-enabled access control system (“ACS”). In some embodiments, the method comprises: identifying using an Access Point Gateway (“APG”) at least one of the one or more connectionless presence devices using a BT-beaconing signal from the at least one of the one or more connectionless presence devices; updating a data store of parameters related to the one or more connection-less presence devices; determining whether any of the one or more connectionless presence devices have not been assigned to an Access Control Module (“ACM”); assigning the one or more connectionless presence devices to an ACM; and updating the status of the ACM.

In some more specific embodiments, the BT-beaconing signal is started in response to detection of a signal transmitted by an APM. In still more specific embodiments, the connectionless presence device is configured to begin transmitting the BT-beaconing signal in response to the location of the connectionless presence device. Other more specific embodiments, further include recording device-identifying information of the at least one connectionless presence device and the corresponding received signal strength of the at least one or more connectionless devices, in the device state data store. Yet more specific embodiments are those further including comparing the corresponding received signal strength measurement to a previous received signal strength measurement.

In still another aspect, the present invention provides a method for controlling access to resources and spaces using one or more connectionless presence devices on a Bluetooth (“BT”)-enabled access control system (“ ”ACS”). In some embodiments, this method of the invention comprises: determining whether any of the one or more connectionless presence devices are communicating with an assigned Access Control Module (“ACM”); establishing connection between the ACM and any of the one or more connectionless presence devices; updating the status of the ACM; and determining, based on based on identifying information and access privilege policy, whether to permit access to a resource or space.

More specific embodiments include those further including marking a connection between the ACM and the at least one connectionless presence device locked-out if the connection has failed. Still more specific embodiments are those further including initiating a communication session using an Access Point Gateway (“APG”); The APG initiates a communication session with the device at step (“6035). During the communication session, the APG requests, from the connected connectionless presence device, identifying information corresponding to the device, a user of the device, or an account linked to the device. Yet more specific embodiments are those further including identifying information corresponding to the device, a user of the device, or an account linked to the device. In still more specific embodiments, the identifying information includes, but is not limited to information selected from the group consisting of: payment account information, a access pass information, ticket information, and access privilege policy information.

These and other aspects and advantages will become apparent when the Description below is read in conjunction with the accompanying Drawings.

### 4 BRIEF DESCRIPTION OF THE DRAWINGS

The features of the present technology will best be understood from a detailed description of the technology and example embodiments thereof selected for the purposes of illustration and shown in the accompanying drawings in which:

FIG. 1 depicts an exemplary Access Control System (ACS), including multiple instances of Access Point Gateways (APGs), according to the present invention.

FIG. 2 depicts an exemplary Access Point Gateway (APG), according to the present invention.

FIG. 3 depicts an exemplary diagram of the components of an Access Point Gateway (APG), according to the present invention.

FIG. 4 depicts an exemplary diagram of the components of an Access Control System (ACS), according to the present invention.

FIG. 5 depicts an exemplary flow of a priority-based Access Control Module (ACM) assignment process, according to the present invention.

FIG. 6 depicts an exemplary process flow that is implemented by an Access Point Gateway (APG) to initiate and terminate one-to-one connections with wireless presence indicating devices, according to the present invention.

### 5 Description of Some Embodiments of the Technology

### 5.1 Overview

The described technologies include a wireless access point control system, further comprising an access control module and one or more wireless access point gateways that extend the capabilities of existing BT-based access control points by enabling connectionless-interactions between the wireless access point gateways and one or more wireless presence indicating devices. Connectionless interactions do not require the establishment of a Bluetooth connection between the wireless devices and the access control points, significantly improving the performance and flexibility of the access control system. By supporting connectionless interactions, the described technologies permit the seamless handoff of moving devices between wireless access point gateways without the need to re-establish a Bluetooth connection to the wireless devices as it moves from one access point gateway to another.

The described technologies further introduce the concept of prioritized wireless device servicing, in which specific types or classes of wireless devices are prioritized for service by the access control system, enabling the provision of assured quality access control decisions.

In various examples provided below, the described technologies are referenced in terms of Bluetooth-based connections and Bluetooth beacons for clarity to the reader. As will be clear to those skilled in the art, the wireless access control point system technologies are applicable to other connectionless wireless protocols without deviating from the scope of the described technologies.

These and other aspects and advantages will become apparent when the Description below is read in conjunction with the accompanying Drawings.

### 5.2 DEFINITIONS

The following definitions are used throughout, unless specifically indicated otherwise:

| TERM | ABBREVIATION | DEFINITION |
|---|---|---|
| Access Control System | ACS | Solves problems associated with known wireless |
| | | communications-enabled access points by |
| | | providing one or more Access Point Gateways |
| | | (APGs) which each include multiple proximately |
| | | located Access Control Modules (ACMs), each of |
| | | which establishes connections with multiple |
| | | wireless presence indicating devices. |
| Access Point Gateway | APG | Comprises an Access Point Module (APM) and an |
| | | Access Control Module (ACM) interface |
| | | component that includes one or more ACMs. |
| Access Point Module | APM | Comprises hardware and software used to discover, |
| | | monitor, and load balance wireless presence |
| | | indicating devices using one or more ACMs. |
| Access Control | ACM | Comprised hardware and software used to detect |
| Module | | signals transmitted by wireless presence indicating |
| | | devices, establish connections and communicate |
| | | with wireless presence indicating devices, and to |
| | | communicate with an APM. Detects |
| | | connectionless messages broadcast by multiple |
| | | wireless presence indicating devices. Establishes |
| | | connections with multiple wireless presence |
| | | indicating devices. |
| ACM Interface | | Comprises one or more ACMs and provides a |
| | | wired or wireless communications interface |
| | | between the APM and the one or more ACMs. |
| Connectionless | | Connectionless messages are wireless signals that |
| message | | are broadcast by wireless presence indicating |
| | | devices and are characterized as being broadcast |
| | | blind, i.e. without requiring a connection or a |
| | | known receiver for the message |
| Bluetooth | BT | A standard for the short-range interconnection of |
| | | electronic devices. |
| Bluetooth Low Energy | BLE | An aspect of the Bluetooth standard focused on low |
| | | power consumption. BLE is particularly used in |
| | | internet-of-things devices such as wireless presence |
| | | indicating devices in order to extend battery life. |

### 5.3 Exemplary System Architecture

An Access Control System (ACS) provides one or more Access Point Gateways (APGs) each of which includes multiple proximately located Access Control Modules (ACMs). Each ACM is configured to establish connections with multiple wireless presence indicating devices. In this way, it solves current problems associated with known wireless communications-enabled access points.

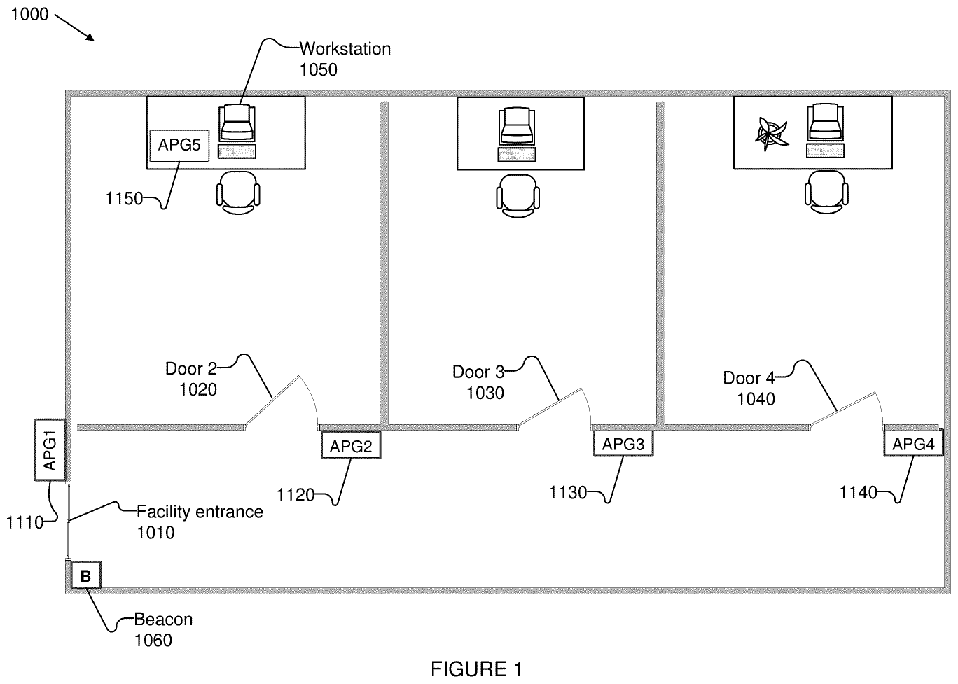

Referring to FIG. 1, an exemplary ACS (1000) includes multiple instances of APGs (APG1-APG5) (1110-1150). APG1 (1110) is disposed to control access through an exterior door (1010) while APG2 (1120), APG3 (1130), and APG4 (1140) are each disposed to control access to an interior door (1020-1040). APG5 (1150) is disposed to control access to a workstation terminal (1050). The exemplary access control system includes one or more optional Bluetooth Beacon devices (B) (1060) (or other location advertising devices) which are each configured to transmit location identification signals, such as Bluetooth Low Energy (BLE) advertising packets.

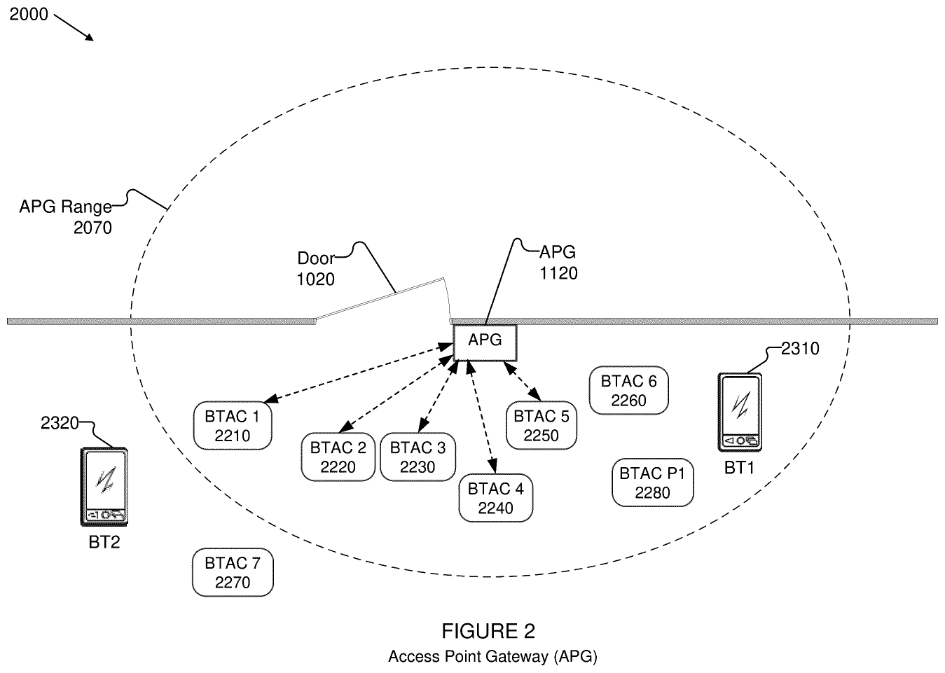

FIG. 2 depicts an exemplary APG (1120), which controls access through a door (1020). The APG has a range (2070), depicted by a dashed line. Wireless presence indicating devices within the range boundary are considered to be in close proximity; wireless presence indicating devices outside the boundary are considered to be out of range. In an exemplary implementation, range (2070) is a configurable parameter and an APG is configured with a range corresponding to a particular situation. For example a first APG range is set to 24 inches in an area where a large number of connectionless presence-indicating devices are normally present, e.g., at a nurse's station, and a second APG range is set to 20 feet in an location where only one connectionless presence device is normally present, for example in a patient's room. The APG monitors connectionless messages that are transmitted by wireless devices within range (2070). Exemplary connectionless messages include Bluetooth transmission signals (such as BLE advertising packets, BT pairing messages, and BT device discovery messages), wireless signals such as RFID query messages broadcast by RFID-enabled devices, and WiFi Direct or WiFi Aware messages broadcast by WiFi-enabled devices. Connectionless messages are characterized as being broadcast “in the blind”, e.g. they do not require synchronization with existing message protocols, and do not require a connection or a known receiver for the message. An APG range can be set by measuring, at the APG, a received signal strength from a connectionless presence device located at a distance from the APG corresponding to the range and configuring the APG to ignore received signals having a received signal strength less than the threshold received signal strength.

In an exemplary configuration implemented using BLE, the APG monitors and tracks connectionless transmission signals broadcast by nearby unconnected wireless presence indicating devices BTAC 1-BTAC 7 (2210-2270) BTAC P1 (2280), and BT1-BT2 (2310-2320). The APG reads the connectionless transmission data, including connectionless presence device identifying information, from individual connectionless transmission signals. Exemplary device identifying information includes UUID, MAC level ID, and advertising data byte pattern. If a connectionless message does not include device identifying information that is recognizable by the APG, the APG determines that a device that transmitted the connectionless message is not a connectionless presence device that is configured to interact with the APG. The APG identifies an individual connectionless presence device that is configured to interact with the APG, and corresponding device priority, based on information included in one or more connectionless messages received from the connectionless presence device or from a connectionless message followed by one or more messages received from the connectionless presence device during a two-way communication session.

The APG tracks signals from wireless presence indicating devices (e.g., by adding or updating an entry in a connectionless presence device's tracking database), and ignores signals that are not identified as being transmitted by wireless presence indicating devices that are configured to interact with the APG. The APG tracks location and relative movement of nearby wireless presence indicating devices based on received signal strength (e.g., measured RSSI) or a difference between received and transmitted signal strength of connectionless transmission signals, or other connectionless messages, received from the wireless presence indicating devices.

The ACS employs mechanisms to prevent or to reduce the impact of spoofing of connectionless messages such as connectionless transmission signals by bad actors. In an exemplary embodiment, a connectionless transmission signal includes a one-time password or code generated by a connectionless presence device. The APG maintains a list of previously used passwords or codes and determines that a connectionless transmission signal is spoofed if it contains a previously used password or code. In an additional exemplary embodiment, an APG transmits a unique identifier, for example a password, hashed message, or code to a connectionless presence device. The connectionless presence device includes the unique identifier in connectionless messages broadcast by the connectionless presence device. In a further exemplary embodiment, if a connectionless presence device fails to authenticate with an APG, the APG marks the connectionless presence device as a spoofed device and ignores subsequent connectionless signals identified as being generated by the connectionless presence device.

The APG connects with and establishes one-to-one communication sessions with the nearby wireless presence indicating devices in a defined precedence order; for example, in order of device priority, proximity, and/or device movement speed. For example, in FIG. 2, wireless presence indicating devices (2210-2260) (2280), and (2310) are all proximate to APG (1120), and connectionless presence device (2280) is a priority device (P1); devices (2270) and (2320) are out of range (2070) and therefore not in proximity.

In an exemplary embodiment, the APG maintains a database of connectionless presence device IDs and a measured received signal strength of each connectionless message received and processed by the APG. The APG determines a connectionless device proximity based on a received signal strength and a connectionless device speed based on changes in signal received signal strength of sequentially received connectionless messages. The APG determines which of the multiple co-located ACMs each connectionless presence device is allowed to connect with, and the number of wireless presence indicating devices each ACM is allowed to connect with. The APG provides each ACM with device IDs for each connectionless presence device that each ACM is allowed to connect with and the ACMs connect with the devices in a manner that balances resource loads among the multiple ACMs and maintains connection availability for high priority devices.

In a particular exemplary embodiment, the APG calculates a total number of wireless presence indicating devices and a total number of priority wireless presence indicating devices in range of the APG. The APG determines whether the total number of wireless presence indicating devices exceeds a capacity of available ACMs. If so, the APG blocks all connectionless presence device connections and then allows only priority wireless presence indicating devices to be serviced (e.g. responded to, or to connect), e.g., by providing device IDs corresponding to priority wireless presence indicating devices to one or more ACMs. In an exemplary embodiment, the APG instructs one or more ACMs to drop one or more interactions with standard (non-priority) wireless presence indicating devices to provide available capacity for interacting with priority wireless presence indicating devices. Once each priority connectionless presence device has been assigned to an ACM, the APG assigns standard wireless presence indicating devices to ACMs that have remaining servicing capacity.

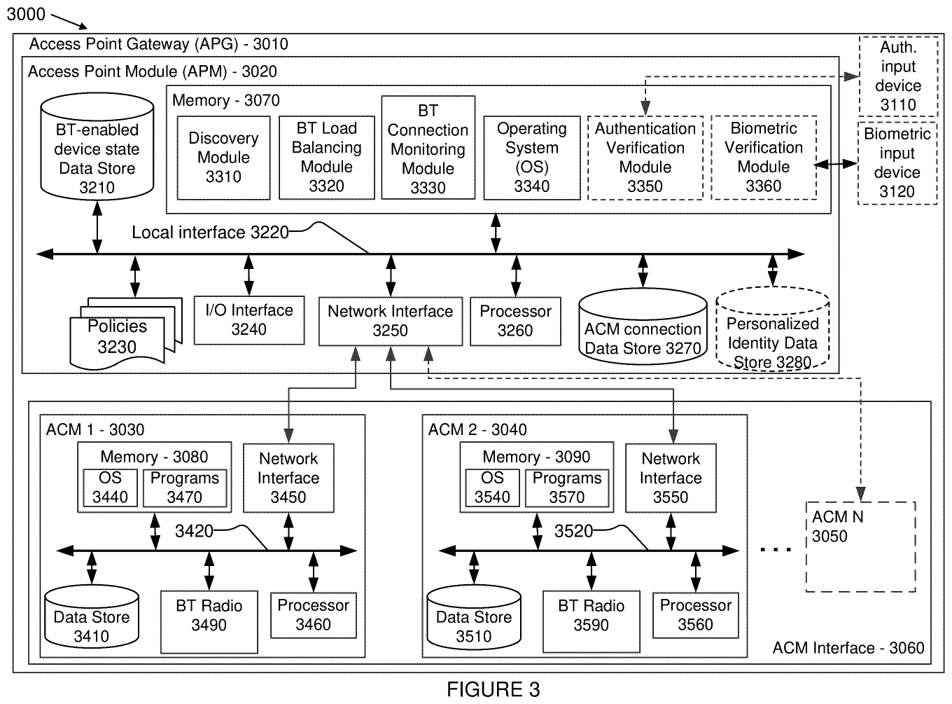

Referring to FIG. 3, an exemplary Access Point Gateway (APG) (3010) includes an Access Point Module (APM) (3020) and an Access Control Module (ACM) Interface component (3060). The ACM interface component includes one or more ACMs (3030, 3040, 3050). As illustrated in FIG. 3, an exemplary embodiment of the APG is deployed as a single device (3010) that includes an APM (3020) and an ACM Interface component (3060) with multiple ACMs (3030, 3040, 3050). In other exemplary embodiments, an APG includes multiple separate components joined together over a network communication structure, such as a LAN or WLAN. In an exemplary embodiment, an APG includes an APM joined, over a wired or wireless network, to two or more individual ACMs or ACM interface components, wherein each ACM interface component includes multiple ACMs.

The network interface (3250) enables the APM to communicate with the ACMs over a bus or network, for example over an Ethernet network or WLAN. The network interface enables the APM to communicate with one or more servers, for example database servers, DNS servers, and web servers, over an Ethernet network, WLAN, WAN, or the Internet. In an exemplary embodiment, the APG and ACMs are enclosed in a single housing comprising the APG, and the network interface is used to enable the APM to communicate with the ACMs over a bus of other wired connection within the housing. In additional configurations (not shown) the ACM interface is a separate component in communication with the APG via a dedicated communication pathway or via a communication network such as a local area network.

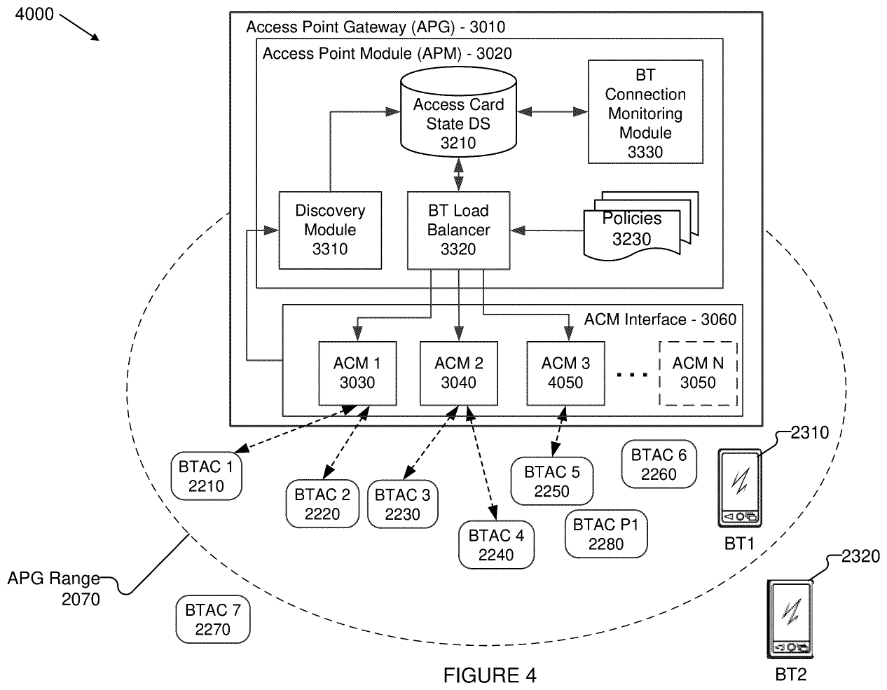

Referring to FIG. 3 and FIG. 4, an APM includes a processor (3260) and memory (3070), which further comprises one or more programs (3310-3360). In an embodiment, the APM is a server or other digital computer that, in terms of hardware architecture, includes a processor (3260), transient and persistent memory (3070) such as RAM, ROM, FLASH memory, and disk-based storage (3210, 3270, 3280), input/output (I/O) interfaces (3240), and a network interface (3250) which are communicatively coupled via one or more buses (3220). The memory includes one or more of volatile memory elements, non-volatile memory elements, and combinations thereof. The memory includes software programs (3310-3360) stored in memory.

The programs stored in memory include a suitable operating system (OS) (3340), BT connection monitoring module (3330), BT load balancing (BLB) module (3320), and a discovery module (3310). The memory optionally includes a biometric verification module (3360) and an authentication verification module (3350). When the APM is in operation, the processor is configured to execute programs stored in the memory.

The APM memory further comprises data stores, including a policies data store (3230), and a wireless presence indicating devices state data store (3210). The policies data store stores policy related information including general and connectionless presence device specific load balancing and access control policies. The connectionless presence device state data store stores data corresponding to wireless presence indicating devices from which the APG has received one or more connectionless messages. Data stored in the connectionless presence device state data store includes, for example, one or more of devices identifying information, device priority, device known/unknown flag, received signal strength of one or more received connectionless messages, and device state data corresponding to one or more wireless presence indicating devices. Exemplary device state data includes device proximity, device movement relative to APG [e.g. approaching|moving away|stationary, device speed], and connected/non-connected status of device.

The APG includes an ACM interface (3060) with co-located access control modules (ACMs) (e.g. ACM1, ACM2, . . . ACMN) (3030-3050). Each ACM is a server or other digital computer that, in terms of hardware architecture, includes a processor (3460, 3560), memory (3080, 3090), a data store (3410, 3510), a network interface (3450, 3550), and a Bluetooth (BT) radio (3490, 3590) which are communicatively coupled via a local interface (3420, 3520) such as a bus or other wired or wireless connections. The BT radio includes an antenna and a transceiver (not shown), in electronic communication with the antenna, to process RF signal data to generate digital, e.g., I/O, RF signal data. The memory includes volatile memory elements, non-volatile memory elements, and combinations thereof, and further comprises software programs stored in memory. The computer programs (3470, 3570) include a suitable operating system (OS) (3440, 3450), a signal processing module for processing digital RF signal data and for identifying connectionless transmission signals, and a communication module for communicating connectionless transmission signal data to the APM. When the ACM is in operation, the processor is configured to execute programs stored in the memory. The ACM includes data stores (3410, 3510) that are used to store data, for example connectionless transmission signal data and signal strength measurement data. The network interface (3450, 3550) is used by the ACM to communicate with the APM over a network, for example over an Ethernet or WLAN network. In an exemplary embodiment, the APM and ACMs are enclosed in a single housing and the network interface is used to enable the ACM to communicate with the APM over a bus or other wired connection within the housing.

Each ACM establishes a BT communication session with eight or more wireless presence indicating devices at a time and receives and processes connectionless transmission signals from as many as 20 or more wireless presence indicating devices simultaneously. An APG is configured by installing, and communicatively coupling to the APM, a number of ACMs to satisfy an anticipated load. When an APG is deployed with two installed ACMs, the APG has the capacity to monitor up to 40 devices and connect with 16. When an APG is deployed with three installed ACMs, the APG has the capacity to monitor up to 60 devices and connect with 24. If an actual load on a deployed APG increases or decreases, ACMs are installed or removed to meet the actual load. These advantages are distinct from the behaviors of traditional BT access control points that only connect to a fixed number of wireless presence indicating devices.

In an exemplary embodiment, the APG includes one or more optional biometric input devices (3120) such as, for example, a camera, a fingerprint scanner, an iris scanner, or a palm print scanner. A biometric input device is used to capture biometric data from a user of the connectionless presence device. The captured biometric data is used by the biometric verification module to authenticate the user to the APG. In an exemplary embodiment, a user is first biometrically authenticated to a connectionless wireless communications-enabled access card to activate the card and then biometrically authenticated to the APG using a same or different biometric authentication method. In another exemplary embodiment, not shown, the APG is communicatively coupled to a separate biometric authentication system that at least includes a biometric input device (3120) and biometric verification module (3360). The separate biometric authentication system authenticates a user and provides authentication results to the APG. An exemplary method for authenticating a user to an APG is discussed in further detail below.

I/O interfaces (3240) are used to receive user input and to provide system output to one or more devices or components. In exemplary embodiments the I/O interfaces include one or more of a keypad, touchscreen, and a physical interface, e.g. a USB interface, for establishing a physical connection with a connectionless presence device and a keypad interface.

In an exemplary embodiment, the I/O interfaces include an optional authentication input device (3110) such as a keypad or touchscreen. A user enters authentication information such as a personal identification number (PIN) or password using the authentication input device. The authentication verification module (3350) uses authentication information entered by a user and pre-enrolled authentication information retrieved from the personalized identity store to authenticate the user.

In an exemplary embodiment, a user connects a connectionless presence device to the APG via an I/O interface and interacts with the APG to authenticate to the connectionless presence device. The user connects a connectionless presence device to the physical interface of the APG, the APG establishes a wired, e.g. USB, communication session with the connectionless presence device, and the user enters a PIN into an I/O keypad of the APG. The APG communicates the entered PIN to the connectionless presence device which uses the PIN to authenticate a user to the connectionless presence device.

Referring to FIG. 4, the Access Control System includes one or more Access Point Gateways (APG) (3010), illustrated with exaggerated scale, each of which controls access to a resource such as a door. The APG is substantially similar to the APG illustrated in FIG. 3 and is illustrated in a simplified view in FIG. 4.

FIG. 2 depicts wireless presence indicating devices BTAC 1 through BTAC 5 (2210-2250) in connection with an APG (1120). FIG. 4 depicts the same relationship, but in greater detail, where BTAC 1-BTAC 5 (2210-2250) are connected to APG (3010), but more specifically, BTAC 1 and BTAC 2 (2210, 2220) are in connection with ACM 1 (3030); BTAC 3 and BTAC 4 (2230, 2240) are in connection with ACM 2 (3040), and BTAC 5 is in connection with ACM 3 (4050). BTAC 6 (2260), BTAC P1 (2280), and BT1 (2310) are proximate to APG (3010) and could establish a connection to an ACM of APG (3010) by going through the ACM assignment process described below.

### 5.3.1 Exemplary Load Balancing Method

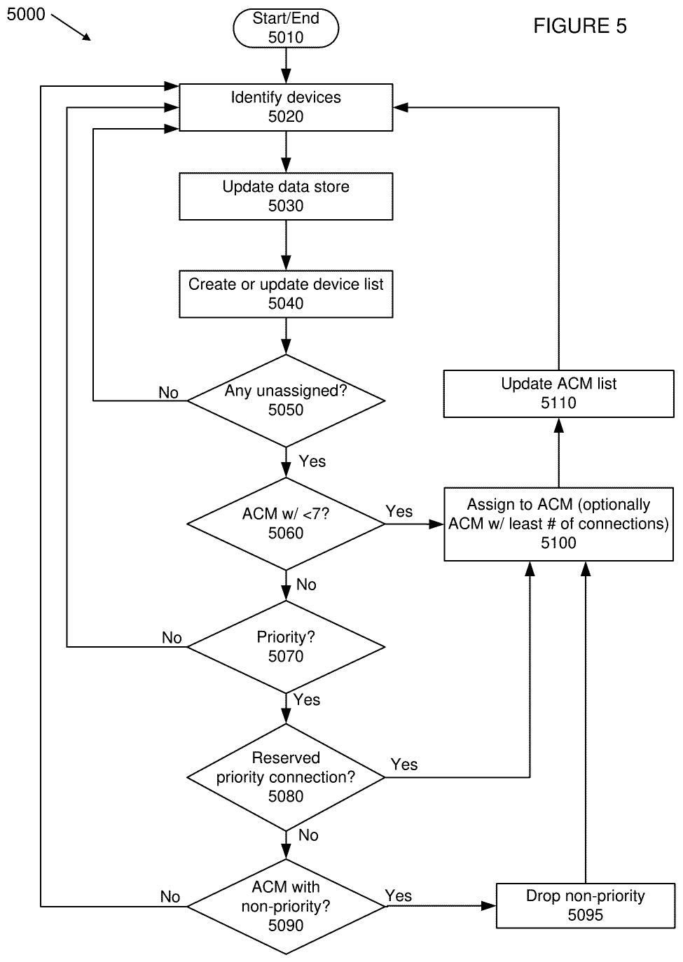

Referring to FIG. 5, the BLB module (3320) begins a priority-based ACM assignment process (5000) wherein device connection prioritization is based on device priority, distance from the APG as estimated by signal strength, or a combination of device priority and distance from the APG.

When a user of a connectionless presence device, for example a standard connectionless presence device (BTAC6) (2260) or a priority connectionless presence device (BTACP1) (2280), approaches an APG from which the user desires access approval, the user activates a beaconing function of the connectionless presence device following which the connectionless presence device periodically transmits connectionless messages, e.g., connectionless transmission signals. In other embodiments, a connectionless presence device is configured to transmit connectionless messages without intervention by a user of the device. In an exemplary embodiment, wireless presence indicating devices are configured to broadcast connectionless messages based upon detection of a signal transmitted by an APM. Alternatively, referring to FIG. 1, a connectionless wireless communications-enabled device is configured to begin transmitting connectionless messages upon receiving a connectionless message from a separate connectionless messages generating device (B) (1060) located at a facility that includes an ACS (1000). An exemplary connectionless message generating device is a connectionless transmission device which periodically transmits connectionless transmission signals. In a further exemplary embodiment, a connectionless presence device includes a location module such as a GPS module or WiFi geolocation module and is configured to begin generating connectionless messages based on a device location determined by the location module. Other BT devices, e.g. smartphone BT1 (2310), also transmit connectionless messages.

At step (5020) the APG scans for beacon signals from wireless presence indicating devices and processes received signals to identify wireless presence indicating devices. Each of the ACMs receives connectionless messages transmitted by wireless presence indicating devices within range (2070). The ACMs receive and process connectionless transmission signal RF data to generate digital RF data. Referring to FIG. 3, each ACM includes a BT radio (3490, 3590). The BT radio includes an antenna and a transceiver. The antenna receives RF spectrum energy and the transceiver processes received RF spectrum energy to generate digital RF energy data, including digital connectionless transmission data.

The ACMs process the digital RF data to identify digital connectionless transmission data. A signal processing module of the ACM identifies and isolates connectionless transmission data from the digital RF energy data. The signal processing module also determines a signal strength metric of each connectionless message and associates the signal strength metric with data corresponding to each digital connectionless transmission data. A communication module of the ACM or ACM interface communicates digital connectionless transmission data and received signal strength data to the APM.

At the APM, the discovery Module (3310) receives digital connectionless transmission data and signal strength data from the ACM interface (3060). The discovery module identifies wireless presence indicating devices by parsing the digital connectionless transmission data to extract identifying data and comparing the parsed identifying data to identifying data stored on the APG.

In an exemplary embodiment, the digital connectionless transmission data includes BLE advertising packet data which includes Bluetooth advertising data (AD). The BT advertising data includes device identifying information and other information such as a state of a device (e.g., authorized or not authorized), a user of the device (e.g., user ID, user authorization), and/or a URL used by the discovery module to determine information about the device or a user of the device. In a first exemplary embodiment, the discovery module parses device identifying information directly from the beacon signal payload data. In a second exemplary embodiment, the discovery module obtains device identifying information using information, for example a UUID or URL, included in beacon signal payload data. In an exemplary embodiment the discovery module accesses a data store containing information linked to UUIDs and obtains corresponding device identifying information from the data store. If beacon signal payload data includes a URL, the discovery module accesses a website corresponding to the URL to obtain device identifying information.

The discovery module retrieves, from policy data store (3230), a list of device identifying information that is assigned to devices that are registered and authorized to interact with the access control system. The discovery module identifies a connectionless transmission signal as being from a connectionless presence device that is connectable to the APG by determining that device identifying information determined based on beacon signal data is included the list of device identifying information stored in memory. The discovery module discards connectionless transmission signal information that are not recognized as signals from known, registered, devices, and thereby effectively blocks unrecognized devices from connection to the APG.

At step (5030), the discovery module records device identifying information of wireless presence indicating devices, and corresponding received signal strength, in the device state data store (3210). If a recognized device was previously unknown, the discovery module creates a new entry for the new device identifying information in the device state data store. Otherwise, the discovery module updates a previous entry for the device identifying information by adding the received signal strength measurement parsed from the signal. If the discovery module receives multiple received signal strength measurement values of a signal form a single device, i.e. multiple measurements of the same signal made by each of multiple ACMs, the discovery module calculates an average value of the multiple received signal strength measurements and records the average value in the device state data store. In an exemplary embodiment wherein an APG includes multiple ACMs or ACM interface modules that are not co-located, the discovery module receives multiple received signal strength measurements from multiple ACMs, determines a received signal strength value with largest magnitude, and records the received signal strength value with the largest magnitude, with a notation of associated ACM identity, in the device state data store.

The discovery module compares a new received signal strength measurement to a previous received signal strength measurement to determine if a particular device is approaching the APG or associated ACM (signal strength increase), moving away from the APG or associated ACM (signal strength decrease), or stationary (no change in signal strength) and makes a corresponding entry [e.g. approaching|moving away|stationary] in a Device State field of the device state data store. The discovery module also calculates a relative speed of a device as a change in received signal strength as a function of time and records the relative speed of the device in the device state data store.

At step (5040) the BLB module creates, or updates an existing, prioritized connection list. The BLB module queries the device state data store to retrieve a set of device identifying information for each device from which it has received one or more connectionless messages, that is within range of the APG, and is not yet connected to an ACM. The BLB module determines a device priority for each approaching or stationary device in the set by retrieving, from the Policies data store, device priority information corresponding to device identifying information of wireless presence indicating devices on the list. The BLB module then orders the set of device identifying information into a list and orders the list based on priority such that the list includes a first group comprising priority devices followed a second, lower ranked, group comprising non-priority devices, thereby generating a prioritized connection list. In an exemplary embodiment, the BLB module further orders devices within each of the first and second groups according to received signal strength. In this manner, all priority device are ranked higher on the list than any non-priority devices, priority devices associated with higher signal strength, relative to other priority devices, are ranked higher than priority devices associated with lower signal strength, and non-priority devices associated with higher signal strength, relative to other non-priority devices, are ranked higher than non-priority devices associated with lower signal strength.

In an exemplary embodiment, the BLB module includes, on the prioritized connection list, devices with Device State equal to approaching and determines a connection order for devices on the list based on a combination of device priority and received signal strength, which is an indication of relative distance from the APG. In another exemplary embodiment, the BLB module also includes stationary devices on the prioritized connection list, thereby including a device carried by a user who is waiting near the APG. In a further arrangement, the BLB module also orders the connection list based, at least in part, on speed of approaching devices, determined based on rate of change of sequential signal strength measurements, and assigns devices that are approaching at a more rapid speed a higher position on the list.

The APG designates a stationary unconnected device as abandoned if the device remains stationary for more than a threshold amount of time. The APG removes the abandoned device from the prioritized connection list or moves the abandoned device to a lower position on the prioritized connection list, thereby reducing a priority ranking of the abandoned device. The APG continues tracking connectionless signals from abandoned devices and changes the state of a device to remove the abandoned designation if the APG detects subsequent motion of the device.

At step (5050), the BLB module begins a series of process steps for assigning each unconnected connectionless presence device for connection to a particular ACM. In an exemplary embodiment, the BLB module begins in a default state wherein no wireless presence indicating devices are assigned to the ACMs and all Bluetooth connections are effectively blocked. The BLB module then begins assigning wireless presence indicating devices for connection to ACMs.

At step (5050) the BLB module determines if there are any wireless presence indicating devices on the connection list that have not been assigned to an ACM. If there are no unassigned devices on the connection list, the process returns to step (5020).

If there is at least one unassigned connectionless presence device on the connection list, the BLB module proceeds to step (5060). The BLB module determines an ACM for the highest ranked connectionless presence device on the connection list to connect with. The BLB module compares the number of devices currently connected to each ACM and selects the ACM with the least number of existing device connections for the highest ranked connectionless presence device to connect with. Because each priority devices is ranked higher on the connection list that any non-priority device, selection of devices for connection in list order ensures that a priority device (e.g. BTACP1 (2280)) will connect to the APG before a non-priority device (e.g. BTAC6 (2260)). Because the connection list is also ranked according to priority device with higher received signal strength than another priority device will connect first.

At step (5060), the BLB module checks the ACM connection data store to determine if the APG includes at least one ACM with fewer than 7 connections to wireless presence indicating devices. A device is assigned for connection to a particular ACM by the BLB module providing identifying information corresponding to the device to the particular ACM.

If the BLB module determines that at least one ACM has fewer than 7 connections, then, at step (5100), the BLB module provides identifying information corresponding to the highest ordered connectionless presence device on the connection list to the AMC with the fewest number of connections, thereby allowing the selected ACM to connect with the device. By only assigning, at step (5060), wireless presence indicating devices for connection to ACMs with fewer than 7 connections, the BLB module reserves, for high priority devices, at least one open connection resource on each ACM. In an embodiment, the number of reserved open connection resources on each ACM is greater than 1. For example, an exemplary BLB module is configured by an administrator to maintain 2, 3, or more open connection resources on each ACM. This is useful for maintaining high priority connection availability at APGs where a large number of high priority devices are anticipated. In an alternative embodiment, the BLB module is configured to not reserve any open connection resources, thereby allowing up to eight non-priority devices to connect to each ACM.

If, at step (5060), the BLB module determines that there are no AMCs with seven or fewer connections, it further determines, at step (5070), whether the highest ordered connectionless presence device on the list is a priority device. If not, the method (5000) returns to step (5020).

If the BLB module determines, at step (5070), that highest ordered connectionless presence device on the prioritized connection list is a priority device, the BLB module determines, at step (5080), if at least one AMC includes at least one reserved priority connection resource. In an embodiment wherein each ACM includes a single reserved priority connection resource, the BLB module determines, at step (5080) whether at least one ACM has fewer than 8 connections. If so, the BLB module assigns, at step (5100), the highest ordered connectionless presence device to an ACM with fewer than 8 connections.

If the BLB module determines, at step (5080) that there are no reserved priority connection resources, the BLB module, at step (5090) determines if any ACMs are connected to at least one non-priority device. If so, at step (5095) the BLB module instructs an ACM to drop a non-priority connection and assigns the priority connectionless presence device to that ACM at step (5100). If the BLB module determines, at step (5090), that there are no non-priority connections that can be dropped to make room for the priority connectionless presence device, the process returns to step (5020).

After a connectionless presence device has been assigned to an ACM at step (5100), the BLB module updates the ACM connection list at step (5110) to add the connectionless presence device to an entry corresponding to the AMC. The process (5000) then returns to step (5020).

The BLB module repeats the ACM assignment process until all unconnected wireless presence indicating devices have been assigned to an ACM or until there are no available ACM connection resources for unassigned and unconnected wireless presence indicating devices.

In an exemplary embodiment, when each ACM has the same number of devices either assigned or connected, the BLB module assigns additional unconnected devices to ACMs in a round robin fashion or in random order. The load balancing process advantageously maintains a lowest possible resource expenditure for each ACM, thereby maintaining high availability of resources to support connection to newly approaching devices. The load balancing process also maintains availability of resources to support connection of priority devices in high load situations. The prioritization and load balancing concepts described herein are advantageous over known art systems that do not include multiple co-located access control modules and therefore do not include means to maintain resource availability under load.

In alternative arrangements, the BLB module does not use the described load balancing method to assign wireless presence indicating devices to ACMs. In a first alternative arrangement, the BLB module assigns additional unconnected devices in order of ACM priority by first assigning unconnected devices to a primary ACM until connection resources of the primary AMC are consumed, and then assigning unconnected devices to each of plurality of additional ACMs, in ACM priority order. In a second alternative arrangement, the BLB module treats all ACMs as peers and assigns unconnected devices in random ACM.

In a third exemplary method, the BLB module assigns unconnected devices in a round robin fashion to and ordered arrangement of ACMs by iteratively assigning a first unconnected device to a first AMC, a second unconnected device to a second ACM, etc. If a particular ACM has no free or unreserved connection resources, the BLB module assigns and unconnected device to the next ACM of the ordered arrangement that has the capability to connect with the unconnected device.

### 5.3.2 Connectionless Presence Device One-to-One Connection

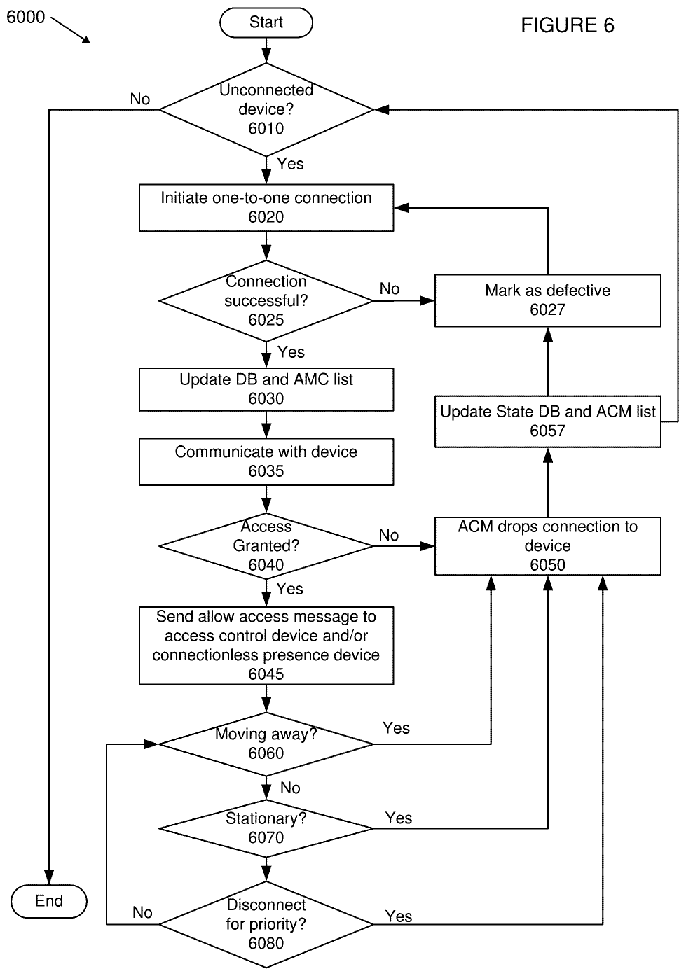

FIG. 6 illustrates an exemplary process flow (6000) that is implemented by an APG to initiate and terminate one-to-one connections with wireless presence indicating devices. At step (6010) an ACM determines whether at least one connectionless presence device assigned to the ACM by the BLB module is not connected, via a one-to-one communication session, with the ACM. If there are no unconnected wireless presence indicating devices assigned to the ACM, method (6000) terminates. If there is at least one unconnected connectionless presence device assigned to the ACM, the ACM initiates a one-to-one connection with an unconnected connectionless presence device at step (6020). In an exemplary embodiment the ACM initiates a BT pairing connection and communication session with a connectionless presence device that has been assigned to the ACM by the BLB module.

If more than one unconnected device is assigned to the ACM, the ACM initiates a one-to-one connection with the assigned devices in a priority order, thereby connecting with priority devices before connecting with non-priority devices. If multiple assigned devices have the same priority ranking, the ACM initiates a one-to-one connection with a closest assigned device, i.e. the device associated with the highest received signal strength value, or with a most rapidly approaching device first, i.e. with the device associated with the most rapidly changing received signal strength value.

If, at step (6025), the ACM is unable to connect with an assigned device, for example due to the device providing incorrect credentials such as an incorrect Bluetooth PIN, the APG, at step (6027), marks the device as defective or spoofed in the connectionless presence device state data store (3210) and locks out the device from further access attempts. The BLB module does not assign the defective or spoofed device to the same or another ACM.

If, at step (6025), a device successfully connects with an ACM then the APG, at step (6030), updates the device state database to change device state to connected and updates an ACM connection list to add the connectionless presence device to a list of devices connected to the ACM.

The APG initiates a communication session with the device at step (6035). During the communication session, the APG requests, from the connected connectionless presence device, identifying information corresponding to the device, a user of the device, or an account linked to the device. Account information includes, for example, identification of a payment account, a transit pass, or ticket information. The APG also requests access privilege policy corresponding to the identifying information from Policies data storage.

At step (6040), the APG determines, based on identifying information and access privilege policy, whether to permit access, e.g. whether a user of the connectionless presence device is allowed to pass through a door or is allowed to log onto a computer terminal controlled by the APG.

If the APG determines that access is allowed, then at step (6045) the APG transmits an allow access message to an access control device such as a lock, a computer associated with the lock, or to a computer terminal, and in response, access is granted by the access control device. In an embodiment, the APG also transmits an allow access message, via the ACM, to the connectionless presence device. The allow access message includes instructions for the device to alter a state of a visual indicator on the device. For example, the APG instructs the device to illuminate a colored LED on the device or to configure a portion of a device screen to display a color.

If access is not granted, the APG instructs the ACM to drop the one-to-one connection with the connectionless presence device at step (6050). In an embodiment, if the APG does not grant access, the APG instructs the connectionless presence device to change the state of a visual indicator on the device, for example to illuminate an LED in a different color than the color for an access allowed state, or a to change a portion of a display screen on the device from one color to another. In some exemplary embodiments, the APG informs an external system that access has been denied. In a particular exemplary embodiment, the APG sends an alert to a security monitoring or security guard system.

When the APG grants access to a connectionless presence device, the APG, at step (6060) it continues to track connectionless signals transmitted by the connectionless presence device and drops a one-to-one connection with the connectionless presence device if the APG detects that the connectionless presence device is moving away from the ACM. The BLB module polls the device state of connected devices and informs an ACM, at step (6050), to drop a connection with a device that is moving away from the APG, i.e. a device that has either passed through the door and is moving away on the other side of the door or that is moving away from the APG without having passed through the door. The BLB module determines that a connectionless presence device is moving away from the APG if consecutive connectionless signals received from the connectionless presence device have decreasing signal strength values. In an exemplary embodiment the APG tracks the number of wireless presence indicating devices that have passed through a door within a configurable period of time, for example within one second or within 1-10 seconds, and if more than one connectionless presence device has passed through the door during the configurable amount of time, determines that multiple wireless presence indicating devices have passed through the door at the same time. In a particular exemplary embodiment, the APG informs an external system, for example a security system, if it detects that multiple connectionless devices have passed through a door at the same time.

At step (6070) the APG designates a stationary device that is connected to an ACM as abandoned if the device remains stationary, i.e. if signal strength values from sequential connectionless signals received from the device do not change, for more than a threshold amount of time. The APG instructs the ACM to disconnect from the abandoned device at step (6050). The APG continues tracking connectionless signals transmitted by abandoned devices and changes the state of a device to remove the abandoned designation if the APG detects subsequent motion of the device.

At step (6080) the APG determines if a connectionless presence device should be disconnected from an ACM to provide connection resources for a priority connectionless presence device. In an exemplary embodiment, the APG determines that a priority device is approaching the APG and that no ACMs are at full connection capacity, i.e. that each ACM is connected to eight wireless presence indicating devices. The APG determines whether at least one ACM is connected to a non-priority device and, if so, instructs the ACM to disconnect, at step (6050), from the non-priority connectionless presence device to free up connection resources for the approaching priority connectionless presence device.

When, at step (6050), an ACM drops the connection with the device, the APG instructs the connectionless presence device to change the state of a visual indicator on the device. In response, a visual indicator on the device changes state, for example an indicator on the device changes color. In an alternative embodiment, the APG does not instruct the connectionless presence device to change the state of a visual indicator of the device. In some embodiments, a connectionless presence device is configured to change the state of a visual indicator of the device in response to a dropped or refused connection with an APG and changes a state of a display of the connectionless presence device so without receiving instructions to do so from an APG.

When a connectionless presence device is disconnected from an ACM the BLB module, at step (6057) updates an entry in a record associated with the connectionless presence device in the device state data store. The BLB module also updates a record of wireless presence indicating devices connected to each ACM. The APG continues to check for unconnected wireless presence indicating devices assigned to and ACM at step (6010).

In an exemplary embodiment, an APG tracks wireless presence indicating devices after they have been connected to and disconnected from the APG. In a first particular exemplary embodiment, a first ACM connects to a connectionless presence device and then disconnects from the connectionless presence device. The first ACM receives and processes connectionless messages from a connectionless presence device after the connectionless presence device has been disconnected. In a second particular exemplary embodiment, a second ACM receives and processes connectionless messages from the connectionless presence device after the connectionless presence device is disconnected from the first ACM. Tracking of wireless presence indicating devices by the second ACM is configured by the APG assigning the second ACM to track the connectionless presence device by the APG providing, to the second ACM, device identifying information corresponding to the connectionless presence device.

In a further exemplary embodiment, one or more additional APGs tracks a connectionless presence device. A first APG receives connectionless messages broadcast by the connectionless presence device when it is in range of the first APG and a second APG receives connectionless messages broadcast by the connectionless presence device when it is in range of the second APG. The first and second APGs exchange information corresponding to the tracked connectionless wireless device with each other, and in some embodiments with one or more additional APGs. The APGs exchange information corresponding to the tracked connectionless presence device either by communicating the information directly between the APGs or communicating the information of a central database or server (not shown) that is accessible to the one or more additional APGs.

### 5.3.3 Supplementary Data and Combining of Data Payloads

Connectionless messages include supplementary data in addition to, or instead of, device identifying information. Exemplary supplementary data includes information about a user of device, account information, e.g., a transit pass balance or payment account information, and personalized identifier information such as a photograph of a user or a biometric template that encodes biometric indicia corresponding to a user. Transmitting supplementary data via connectionless messages such as beacon signals is advantageous in that transmitting connectionless messages, as opposed to establishing and maintaining one-to-one communication sessions, requires less power and preserves battery reserves of wireless presence indicating devices. Transmitting supplementary data, including, for example, personalized identifier information, employee photographs, and face templates, from a connectionless presence device to an APG is advantageous at least in that it obviates a need to store the supplementary data at each APG of an access control system.

In exemplary embodiments, a connectionless message payload, for example personalized identifier information, includes a block of data that is too large to be included in a single beacon signal data packet. An exemplary APG receives individual sub-blocks of the too-large block of data wherein each individual sub-block is received as beacon signal payload data in a separate connectionless message. The exemplary APG combines the sub-blocks of data to generate the too-large block of data.

In a first particular exemplary embodiment, an APG receives multiple connectionless message data packets, each of which contains a sub-block, i.e. a portion of, a block of data that is too large to be included in a single connectionless message data packet. The discovery module (3310) combines sub-blocks of data from multiple data packets to re-create a block of data. In an embodiment, each individual connectionless message data packet comprising a sub-block of data includes a reference to one or more other data packets that each contains an additional sub-block of data from the same block of data. For example, an APG receives multiple chained BLE advertising data packets wherein a first advertising data packet in the chain references a second advertising data packet in the chain, the second advertising data packet references a third advertising data packet, etc.

In a second particular exemplary embodiment, the APG receives, from a connectionless presence device, a first advertising data packet containing a first sub-block of data and responds with a scan request addressed to the connectionless presence device. The APG receives, from the connectionless presence device in response to the scan request, a scan response that includes a second sub-block of data. The APG continues sending scan requests to the connectionless presence device, and receiving scan responses from the connectionless presence device until the APG receives a scan response from the connectionless presence device that indicates that no more sub-blocks of data are available for transmission, i.e. that an entire block of data has been transmitted.

An exemplary block of data that is received from a connectionless presence device in multiple related connectionless message data packets includes personalized identity data such as a user photograph, or a face template derived from an enrollment photograph of a user, that is useable by a biometric verification module (3360), e.g. a face recognition module, comprising or associated with an APG to confirm an authentication of a user. An APG receives multiple connectionless message data packets, for example a string of BLE 5.0 extended advertising packets, from a connectionless presence device wherein each connectionless message data packet includes a portion of a personalized identity data structure such as a user image or face template. The discovery module extracts data comprising sub-blocks of the personalized identity data structure, e.g. of a user image or face template, from each of the connectionless message data packets and combines the sub-blocks of data to generate a block of data comprising the personalized user identity data structure. The discovery module stores the re-constructed personalized user identity data structure, e.g., the user image or face template, in a personalized identity data store.

Alternatively, the APG receives, from a connectionless presence device, a first connectionless message that includes an indication that the connectionless presence device that transmitted the first connectionless message is capable of providing, via beacon or other connectionless messages, data such as personalized identifier information. If the APG desires access to the personalized identifier information, the APG transmits a connectionless request message, e.g., a BLE scan request data packet, to the connectionless presence device to request the personalized identifier information. The connectionless presence device responds with one or more connectionless response messages, e.g., one or more BLE scan request data packets, that each includes a portion of the personalized identifier information.

An APG is configured to request, via a connectionless message, additional information from a connectionless presence device based on information, for example identifying information, contained in a beacon signal received, by the APG, from the connectionless presence device. In an embodiment, an APG receives a connectionless message from a connectionless presence device and determines additional information to request from the connectionless presence device based on information contained in the beacon signal. The APG transmits, to the connectionless presence device, a connectionless message, for example a BLE scan request data packet that includes a request for the additional information.

In a further embodiment, the APG receives supplementary information, e.g. personalized identifier information, from a connectionless presence device during a one-to-one communication session with the connectionless presence device.

### 5.3.4 Authentication to APG

In an exemplary embodiment, a user of a connectionless wireless communications-enabled device is required to authenticate directly to an APG prior to being granted access to a resource protected by the APG. The user is required to authenticate by one or more of: (1) entering authentication data and (2) biometrically authenticating to the APG. Authentication data includes one or more of PIN, user name, and password. Referring to FIG. 3, an exemplary APG includes a biometric input device (3120), biometric verification module (3360), authentication input device (3110), authentication verification module (3350), and a personalized identity data store (3280). The personalized identity data store includes pre-enrolled biometric indicia and pre-provisioned authentication data associated with users who are allowed to authenticate to the APG and access a resource that is protected by the APG.

The biometric input device (3120) collects biometric scan data, for example a face scan, iris scan, or palm scan, from a user of a connectionless presence device. The biometric verification module (3360) receives, from the biometric input device, biometric indicia such as a scanned biometric image (e.g., a fingerprint image) or a biometric template generated by an algorithm of the biometric input device based on the biometric scan data. The biometric verification module retrieves, from the personalized identity data store (3280), one or more pre-enrolled biometric indicia and attempts to determine a match between the just obtained biometric indicia and pre-enrolled biometric data in order to authenticate the user presenting the biometric indicia. If the biometric verification module determines the pre-enrolled and currently scanned biometric indicia match, it authenticates the user.

The authentication input device (3110) includes a data input device such as a keyboard or touch screen. The authentication input device collects authentication data from a user. The authentication verification module (3350) receives, from the authentication input device, the authentication data that was collected from the user. The authentication verification module retrieves, from the personalized identity data store (3280), pre-enrolled authentication data and attempts to determine a match between the just obtained authentication data and pre-enrolled authentication data in order to authenticate the user presenting the authentication data. If the authentication verification module determines the pre-enrolled and just entered authentication data match, it authenticates the user.

In this manner, an APG that provides access to a high-security resource performs verification of a user, in addition to verification performed by a connectionless presence device, before granting the user access to the high security resource.

### 5.3.5 APG Configured as a Payment Terminal

In an embodiment, an APG is configured to function as a payment terminal, i.e. the APG is configured as an APG payment terminal. In an exemplary embodiment, the APG payment terminal requires that a user of a connectionless presence device provide a payment prior to being allowed access to a resource such as a mass transport system or a computer terminal. In some exemplary embodiments, an APG payment terminal does not establish a one-to-one connection with a connectionless presence device until a payment has been successfully received from the connectionless presence device.

An exemplary APG payment terminal monitors and tracks wireless presence indicating devices and collects payments from the wireless presence indicating devices prior to granting access to a resource protected by the APG payment terminal. In a particular exemplary embodiment, the APG payment terminal conducts a payment transaction with a connectionless presence device at least in part using an exchange of connectionless message. The APG payment terminal broadcasts a connectionless transmission signal that includes an identifier associated and a first connectionless device and session key data.

After the first connectionless presence device receives and processes the connectionless message, the first connectionless presence device responds by transmitting a response connectionless message. The APG payment terminal receives a response connectionless message from the first connectionless presence device. In an exemplary embodiment, the response connectionless message includes transaction data generated by the first connectionless presence device using the session key data that was included in the connectionless message previously broadcast by the APG payment terminal. The transaction data includes, for example, payment account information or transit account information associated with a user of the first connectionless presence device. The APG payment terminal processes the response connectionless message to extract the transaction data and then uses the transaction data to process a payment transaction, for example by contacting a third party system to request a payment from a payment account identified by the transaction data. The APG payment terminal constructs a confirmation connectionless message that includes an identifier associated with the first connectionless presence device as well as transaction confirmation data and broadcasts the confirmation connectionless message to the first connectionless device. In a further exemplary embodiment, the APG payment terminal requires a user to re-authenticate with the first connectionless presence device, or in an alternate embodiment directly with the APG payment terminal, prior to the APG payment terminal processing a payment request. In an exemplary embodiment, the APG payment terminal displays a confirm purchase request that includes a notification that a user is required to re-authenticate or otherwise interact with the first connectionless presence device to confirm a payment transaction. The APG payment terminal does not process the transaction or transmit a transaction confirmation connectionless message until it receives a connectionless message from the first connectionless device that includes confirmation data that indicates the user successfully re-authenticated with the connectionless presence device. In another exemplary embodiment, the APG payment terminal does not process the transaction or transmit a transaction confirmation connectionless message until a user successfully authenticates with the APG payment terminal, for example by successfully authenticating to the APG payment terminal biometric input device or authentication input device.

The described payment transaction process using an exchange of connectionless messages is advantageous in that it enables a transaction to be completed without establishing a one-to-one connection, thereby decreasing transaction time and decreasing use of battery resources to increase battery life of a connectionless presence device. The connectionless messages are transmitted only a short period of time, for example for 1 second or 2 seconds, thereby reducing security risk.

### 5.3.6 Beacon Device Activating Non-Authenticated Beacon Signal Transmission

Referring to FIG. 1, an exemplary facility includes a beacon device (B) (1060) that broadcasts a non-connectable beacon message. In an embodiment, a connectionless presence device is configured to begin transmitting beacon signals upon receiving a non-connectable beacon message without a user interacting with a connectionless presence device. The beacon device is positioned close to a facility entrance (1010) so that when a user enters the facility, a connectionless presence device begins transmitting unauthenticated connectionless messages. In another exemplary configuration, an APG transmits beacon messages that are configured to cause wireless presence indicating devices to begin transmitting unauthorized beacon signals. Connectionless messages sent by the beacon device or by an APG include additional instructions for a connectionless presence device, for example a beacon interval, how long the device continues transmitting connectionless messages, etc.

Connectionless messages transmitted by a beacon device or by an APG include a heartbeat message, which informs a connectionless presence device to continue transmitting beacon signals for a configurable period of time and to stop transmitting connectionless messages if another heartbeat message has not been received by the connectionless presence device within the configurable period of time. Instructions sent by an APG to a connectionless presence device are configured based on identifying information received by the APG in a connectionless message from the connectionless presence device.

At least some of the APGs within the facility (e.g. APG1-APG5) (1120-1150) are communicatively coupled together via a LAN or WLAN. If a first APG receives connectionless messages from a connectionless presence device, the first APG extracts identifying information from the connectionless messages and communicates the identifying information to other APGs. APGs, or APMs, positioned throughout the facility detect connectionless messages, share connectionless presence device identifying information, and track the location of a connectionless presence device throughout the facility. In some embodiments, a user is required to interact with the connectionless presence device to initiate transmission, by the connectionless presence device, of connectionless messages, e.g. authenticated beacon signals, that include data necessary for an authentication decision by an APG.

### 5.3.7 APG Configured to Interact with Only a Subset of Wireless Presence Indicating Devices

In an embodiment, an APG or APM is configured to interact with, and connect to, only a subset of a group of wireless presence indicating devices. An access control system is configured with a master list of identifying information that includes identifying information for each of a group of wireless presence indicating devices that are enrolled and authorized to interact with the access control system. Each APG or APM of an access control system is configured with a sub-list of identifying information that includes fewer entries than the master list.

Referring to FIG. 1, in an exemplary embodiment, an access control system includes a master APG (APG1) (1110) that is configured to interact with, and make access control decisions, for all wireless presence indicating devices that are enrolled and authorized for the access to the facility. Each of the APGs (APG2, APG3, APG4, APG5) (1120-1150) is configured to interact with and make access control decisions for a sub-set of the wireless presence indicating devices that are enrolled and authorized by provisioning each of the APGs with a list that includes only the sub-set of wireless presence indicating devices and configuring each APG to only interact with wireless presence indicating devices on the provisioned list.

In another embodiment, an APG of an access control system is configured to recognize a first specific type or class of wireless presence indicating devices while other APGs of the access control system are configured to recognize a second type or class of wireless presence indicating devices. A first APG is configured to recognize and track a first type of connectionless presence device, for example wireless presence indicating devices corresponding to visitors, which the first APG recognizes based on identifying information broadcast by the connectionless presence device in a beacon signal. The first type of wireless presence indicating devices is identified by the first APG based on identifying information being included on a visitor list that the first APG is provisioned with or by identifying information that is not included on a list that includes non-visitor wireless presence indicating devices. In an exemplary embodiment, the first APG recognizes a visitor and alerts security aspects of the access control system, for example visitor tracking aspects such as beacon signal tracking aspects or tracking security cameras, or security personnel. Other APGs in the access control system are configured to only track, and interact with, wireless presence indicating devices that broadcast connectionless messages that include identifying information corresponding to enrolled and registered employees.

### 5.3.8 Provisioning of Shared Key for Encrypting Beacon Signals

In an embodiment, an APG provisions a connectionless presence device and other APGs within a facility with a cryptographic shared key to enable an encrypted connectionless message exchange. Referring to FIG. 1, in an exemplary arrangement, a connectionless presence device is required to establish a one-to-one BT connection with APG1 (1110) prior to a user of the connectionless presence device gaining entry to the facility. APG1, via a one-to-one communication session with the connectionless presence device, provisions the connectionless presence device with a cryptographic shared key which is also shared with one or more APGs within the facility, i.e. APG2, APG3, APG4, and APG5 (1120-1150). The connectionless presence device subsequently transmits encrypted connectionless messages.

It will also be recognized by those skilled in the art that, while the technology has been described above in terms of preferred embodiments, it is not limited thereto. Various features and aspects of the above described technology may be used individually or jointly. Further, although the technology has been described in the context of its implementation in a particular environment, and for particular applications (e.g. access control and security), those skilled in the art will recognize that its usefulness is not limited thereto and that the present technology can be beneficially utilized in any number of environments and implementations where it is desirable to support a large number of connectionless presence indicating devices, and to provide assured performance to one or more of these devices. Accordingly, the claims set forth below should be construed in view of the full breadth and spirit of the technology as disclosed herein.

What is claimed:

1. A Bluetooth-enabled access control system for enabling selective entrance and use of resources and spaces based on a connectionless presence device according to an access security policy, the system comprising:
an access point gateway comprising:
at least one access control module; and
an access point module configured to discover, monitor, and balance a communications load of connectionless presence devices in electronic communication with the at least one access control module.

2. The system of claim 1, wherein the access point module comprises:
an access card state data store; and
a load balancer configured to communicate with the at least one access control module and the access card data store.

3. The system of claim 1, wherein the access point module comprises:
a discovery module; and
a Bluetooth connection monitoring module.

4. The system of claim 1, wherein the access point module comprises a biometric verification module configured to verify at least one biometric parameter related to a connectionless presence device.

5. The system of claim 4, further comprising a biometric input device, wherein the biometric verification module is further configured to communicate electronically with the biometric input device.

6. The system of claim 5, wherein the biometric input device comprises at least one input device selected from the group consisting of:
a camera;
a fingerprint scanner;
an iris scanner; and
a palm print scanner.

7. The system of claim 1, wherein the access point module further comprises a personalized identity data store.

8. The system of claim 1, further comprising a plurality of access point gateways.

9. The system of claim 8, wherein one of the plurality of access point gateways is a master access point gateway configured to interact with and make access control decisions for all of the connectionless presence devices.

10. The system of claim 9, wherein the remainder of the plurality of access point gateways other than the master access point gateway are:
configured to interact with and make access control decisions for a subset of the connectionless presence devices, the subset being enrolled and authorized by the master access point gateway; and
provisioned with a list comprising only the subset of the connectionless presence devices, wherein each of the remainder of the plurality of access point gateways is configured to only interact with the subset of the connectionless presence devices on the list.

11. A method for controlling access to resources and spaces using one or more connectionless presence devices on a Bluetooth-enabled access control system, the method comprising:
identifying, by an access point gateway, at least one of one or more connectionless presence devices using a Bluetooth beaconing signal from the at least one of the one or more connectionless presence devices;
updating a data store of parameters related to the at least one connectionless presence device;
determining whether the at least one connectionless presence device has not been assigned to an access control module;
determining whether an access control module is available for assignment to the at least one connectionless presence device;
assigning the at least one connectionless presence device to an access control module; and
updating a status of the assigned access control module.

12. The method of claim 11, wherein the Bluetooth beaconing signal is started in response to detection of a signal transmitted by an access point module.

13. The method of claim 11, wherein the one or more connectionless presence devices are configured to begin transmitting the Bluetooth beaconing signal in response to a location of the one or more connectionless presence devices.

14. The method of claim 11, updating a data store of parameters related to the at least one connectionless presence device comprises recording, in the device data store, device identifying information of the at least one connectionless presence device and a corresponding received signal strength of the at least one connectionless presence device.

15. The method of claim 14, further comprising comparing the corresponding received signal strength of the at least one connectionless presence device to a previously received signal strength of the at least one connectionless presence device.

16. A method for controlling access to resources and spaces using one or more connectionless presence devices on a Bluetooth-enabled access control system, the method comprising:
determining whether one of the one or more connectionless presence devices is communicating with an assigned access control module;
establishing a connection between the assigned access control module and the one connectionless presence device;
updating a status of the assigned access control module; and
determining, based on identifying information and an access privilege policy, whether to permit access to a resource or space.

17. The method of claim 16, further comprising marking the connection between the assigned access control module and the one connectionless presence device locked-out if the connection has failed.

18. The method of claim 16, further comprising initiating a communication session using an access point gateway.

19. The method of claim 18, wherein the communication session comprises:
identifying information corresponding to one of the one or more connectionless presence devices;
a user of one of the one or more connectionless presence devices; or
an account linked to one of the one or more connectionless presence devices.

20. The method of claim 19, wherein the identifying information comprises information selected from the group consisting of:
payment account information;
an access pass information;
ticket information; and
access privilege policy information.
